(19) United States
(12) Patent Application Publication
(10) Pub. No.: US 2025/0351838 A1
(43) Pub. Date: Nov. 20, 2025

(54) BAKING PROCESS OF HIGH-QUALITY GREEN TEA FOR BEVERAGE

(71) Applicant: Tea Research Institute, Chinese Academy of Agricultural Sciences, Hangzhou City, Zhejiang Province (CN)

(72) Inventors: Junfeng YIN, Hangzhou City (CN); Weihong HUANG, Hangzhou City (CN); Xiang YAN, Hangzhou City (CN); Gensheng CHEN, Hangzhou City (CN)

(73) Assignee: Tea Research Institute, Chinese Academy of Agricultural Sciences, Hangzhou City, Zhejiang Province (CN)

(21) Appl. No.: 19/028,773

(22) Filed: Jan. 17, 2025

(30) Foreign Application Priority Data
May 20, 2024 (CN) 202410625156.2

(51) Int. Cl. A23F 3/22; F24C 7/06; F24C 7/08; F24C 15/00

(52) U.S. Cl. CPC A23F 3/22; F24C 7/06; F24C 7/087; F24C 15/003

(57) ABSTRACT

A baking process of high-quality green tea for a beverage is provided. The baking process includes: 1) providing a tea baking device; 2) conducting first moisture regaining; 3) conducting baking preparations; 4) conducting segmented baking; and 5) conducting preservation. By applying a far-infrared component, a heating component, and a humidification component, the moisture in the green tea is quickly removed by far-infrared baking when the green tea has a high moisture content, reshaping the green tea under the action of high temperature and high humidity while promoting the transformation of endogenous substances in green tea. The heating component improves the overall aroma and taste quality of green tea and promotes the leaching of green tea substances by hot air baking when the green tea has a low moisture content, making baked green tea samples show a strong and lasting aroma as well as a rich taste.

### CROSS REFERENCE TO RELATED APPLICATION

This patent application claims the benefit and priority of Chinese Patent Application No. 202410625156.2, filed with the China National Intellectual Property Administration on May 20, 2024, the disclosure of which is incorporated by reference herein in its entirety as part of the present application.

### TECHNICAL FIELD

The present disclosure relates to the technical field of tea processing, and in particular to a baking process of high-quality green tea for a beverage.

### BACKGROUND

The baking process, as a key step to enhance the aroma and taste of tea, is involved in both the initial and refined stages of tea making, and has a wide range of applications in quality stabilization and diversified cross-border development.

Green tea is one of the important raw materials for tea beverages and can be used to produce green tea beverages with different styles and characteristics, such as plain tea, roasted tea, and fried tea. The characteristics and quality of green tea raw materials are particularly important. During actual production and processing, baking is widely used as an important means to improve and stabilize the flavor quality of green tea, and is conducive to improving the overall aroma and taste of green tea, and highlighting the rich aroma and taste of baked green tea, thereby meeting the demands to be the raw materials of high-quality tea beverage.

At present, tea baking methods include cage baking, hot air baking, far-infrared baking, and drum baking, and their effects on the formation and stabilization of tea flavor quality are not the same. The hot air baking is widely used due to advantages such as low production cost and low energy consumption. However, for some hot air baking machines (such as JH-6CH2-6 box-type baking machine), the inner temperature of each part in the box is different and the actual leaf temperature is below the preset temperature, making the same batch of tea leaves deteriorate in quality due to uneven heating and a poor production efficiency due to discontinuous production. The far-infrared baking allows even heating, makes the tea leaves have better appearance color and aroma persistence, and manages continuous production. However, the far-infrared baking has a high heat transfer speed, leading to the issue that the temperature is difficult to control and requires experienced operators to handle during the baking. Otherwise it is easy to cause uneven baking of tea leaves. The drum baking is conducive to the formation of chestnut and roast flavors and rich taste of tea, but has an adverse impact on the color of dry tea and tea soup. Therefore, it is extremely necessary to propose a baking process of high-quality green tea for beverage, so as to improve the production quality of tea raw materials.

### SUMMARY

The objective of the present disclosure is to provide a baking process of high-quality green tea for a beverage. The baking process can improve the production efficiency of green tea baking and improve the production quality of green tea baking to solve the existing technical defects and to achieve unattainable technical requirements.

To achieve the above objective, the following technical solutions are provided: the present disclosure provides a baking process of high-quality green tea for a beverage, including the following steps:
1) providing a tea baking device, including:
1.1) a box, where an inner side wall of the box is provided with a partitioning mesh plate, and a vertical tubular far-infrared component, a heating component, a humidification component, a detection component, and a screening component are arranged inside the box;
2.2) the vertical tubular far-infrared component includes a far-infrared heating quartz tube, where the far-infrared heating quartz tube is fixedly arranged between the inner side wall of the box and the partitioning mesh plate;
a control box, where the control box is arranged at a top of the box, and the control box is electrically connected to the far-infrared heating quartz tube to control a heating temperature of the far-infrared heating quartz tube;
2.3) the heating component includes an electric heater, where the electric heater is arranged on a rear side wall in the box, and the electric heater is electrically connected to the control box;
an exhaust fan, where the exhaust fan is arranged on one side of the electric heater, and the exhaust fan is electrically connected to the control box;
2.4) the humidification component is arranged inside the box, and the humidification component is electrically connected to the control box to adjust a relative humidity inside the box;
2.5) the screening component includes a tray, where the tray is distributed at intervals inside the box, a bottom of the tray is arranged in a mesh shape, and the tray is drawable out of the box;
a vibrator, where the vibrator is fixedly connected to the tray, the vibrator is arranged on two sides of the tray, and the vibrator is electrically connected to the control box;
a recovery groove, where the recovery groove is distributed at intervals inside the box, and the recovery groove is correspondingly arranged below the tray;
2.6) the detection components include a temperature sensor, where the temperature sensor has one end fixedly arranged on the inner side wall of the box and the other end extending above the tray, and the temperature sensor is electrically connected to the control box to provide feedback on a temperature inside the box; and
a humidity sensor, where the humidity sensor has one end fixedly arranged on the inner side wall of the box and the other end extending above the tray, and the humidity sensor is electrically connected to the control box to provide feedback on a humidity inside the box;
it should be emphasized that the control box in the present disclosure can be remotely controlled, that is, all components controlled by the control box can be regulated by remotely controlling the control box;
2) conducting first moisture regaining: placing a frozen green tea sample to be baked in the tea baking device provided in step 1) to allow the first moisture regaining, such that the frozen green tea sample to be baked has a moisture content of 10% to 13%;
3) conducting baking preparations:
3.1) spreading a green tea sample obtained after the first moisture regaining treatment in a cooling trough to allow a primary standing treatment; and
3.2) placing a green tea sample obtained after the primary standing treatment into cloth bags to allow a secondary standing;
4) conducting segmented baking:
4.1) conducting a first stage:
4.1.1) placing a bagged green tea sample obtained after the secondary standing treatment in the box, and keeping a box door slightly open;
it should be explained here that the box door is a door set on the box; although not being emphasized in the structure, the box door is a conventional design, so it is explained here; at the same time, the slightly open state in the above content means that the box door is not tightly shut and left a gap to ensure that odor and moisture in the box are discharged without excessively affecting temperature and humidity of an internal environment of the box, and then ensure that an airflow in the box can circulate;
4.1.2) turning on the vertical tubular far-infrared component, the heating component, and the humidification component to allow first heating of the green tea sample placed in the box at relatively constant temperature and humidity; and
4.1.3) stopping the first heating when the green tea sample has a moisture content of the green tea sample drops 6% to 8%;
4.2) conducting a second stage:
4.2.1) taking out a green tea sample obtained after the first baking treatment from the cloth bags and then placing in the cooling trough to allow second moisture regaining;
4.2.2) spreading a green tea sample obtained after the second moisture regaining treatment on the tray, and then closing the box door;
4.2.3) turning on only the heating component and the humidification component to allow second heating of the green tea sample; and
4.2.4) stopping the second heating when the green tea sample has a moisture content of 3% to 5%; and
4.3) conducting a third stage: subjecting a green tea sample obtained after the second baking treatment to vibratory screening, and taking out from the tray after the vibratory screening is completed; and
5) conducting preservation: cooling a green tea sample obtained after the vibratory screening treatment, putting the tea into an aluminum foil bag, and then subjecting the aluminum foil bag containing the green tea sample to low-temperature preservation.

Preferably, the first moisture regaining in step 2) specifically includes: placing the green tea sample in the tray, closing the box door, turning on the heating component and the humidification component to maintain the ambient temperature of 25° C. to 30° C. and a relative humidity of 80% to 85% inside, and then treating the green tea sample for 4 h to 6 h while turning over the green tea sample every 1 h.

Preferably, the primary standing in step 3.1 specifically includes: spreading the green tea sample obtained after the first moisture regaining treatment at a spreading thickness of 10 cm to 15 cm in the cooling trough to allow standing for 0.5 h to 1 h.

Preferably, the secondary standing in step 3.2 specifically includes: placing the green tea sample obtained after the primary standing treatment into the cloth bags, with each of the cloth bags has 3 kg to 5 kg of the green tea sample and the green tea sample is spread at a spreading thickness of 5 cm to 10 cm, and allowing to stand for 15 min to 30 min.

Preferably, the first heating in step 4.1.2) specifically includes: turning on the vertical tubular far-infrared component and the heating component to reach an ambient temperature of 100° C. to 110° C. inside the box, turning on the humidification component to reach a relative humidity of 15% to 20% inside the box, and then heating the green tea sample for 3 min to 5 min.

Preferably, the second moisture regaining in step 4.2.1) specifically includes: spreading the green tea sample obtained after the first stage treatment at a spreading thickness of 15 cm to 20 cm in the cooling trough to allow the second moisture regaining for 0.5 h to 1 h.

Preferably, step 4.2.2) specifically includes: spreading the green tea sample obtained after the second moisture regaining treatment on the tray at a spreading thickness of 3 cm to 5 cm so that the tray has 1.5 kg to 3 kg of the green tea sample, and then closing the box door.

Preferably, the second heating in step 4.2.3) specifically includes: turning on the heating component to reach an ambient temperature of 80° C. to 90° C. inside the box, turning on the humidification component to reach a relative humidity of 15% to 20% inside the box, and then heating the green tea sample for 10 min to 20 min.

Preferably, the vibratory screening in step 4.3) specifically includes: turning on the vibrator to allow green tea dregs in the tray to fall into the recovery groove, and then stopping the vibratory screening after no more green tea dregs fall from the tray.

Preferably, the green tea sample obtained after the vibratory screening treatment is cooled at the room temperature, and the low-temperature preservation is conducted at 4° C. to 8° C. in step 5).

It should be emphasized that the ambient temperature and humidity set during heating in the present disclosure are based on the values fed back by the temperature sensor and humidity sensor to avoid data errors caused by environmental factors by directly setting the temperature of the instrument. The environmental factors include: the thermal conductivity of the components inside the box, and the contact with the outside air when the box door is opened, which may dissipate the heat and moisture inside the environment to the outside of the box.

Compared with the existing methods, benefits of the present disclosure are as follows:

By setting a far-infrared component, a heating component, and a humidification component, the moisture in the green tea is quickly removed by far-infrared baking when the green tea has a high moisture content, reshaping the green tea under the action of high temperature and high humidity by promoting the transformation of endogenous substances in green tea. Meanwhile, the heating component improves the overall aroma and taste quality of green tea and promotes the leaching of green tea substances by hot air baking when the green tea has a low moisture content, making baked green tea samples show a strong and lasting aroma as well as a rich taste. Moreover, compared with the traditional single baking process, this novel baking process can better highlight the characteristic flavor quality of green tea, and the combination of far-infrared baking and hot air baking in a segmented temperature-variable baking method also improves the production efficiency during green tea baking.

### BRIEF DESCRIPTION OF THE DRAWINGS

FIG. 1 is an overall processing flow chart of the present disclosure;

FIG. 2 is a schematic diagram for the overall structure of the tea baking device in the present disclosure;

FIG. 3 is the partial enlarged schematic diagram of the Point A in FIG. 1 of the present disclosure; and

FIG. 4 shows the cross-sectional view of the tea baking device in the present disclosure; where
reference numerals are: box 1, partitioning mesh plate 2, far-infrared heating quartz tube 3, control box 4, electric heater 5, exhaust fan 6, tray 7, recovery groove 8, temperature sensor 9, and humidity sensor 10.

### DETAILED DESCRIPTION OF THE EMBODIMENTS

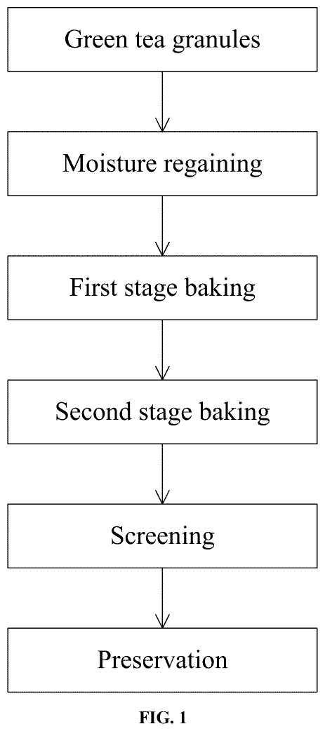

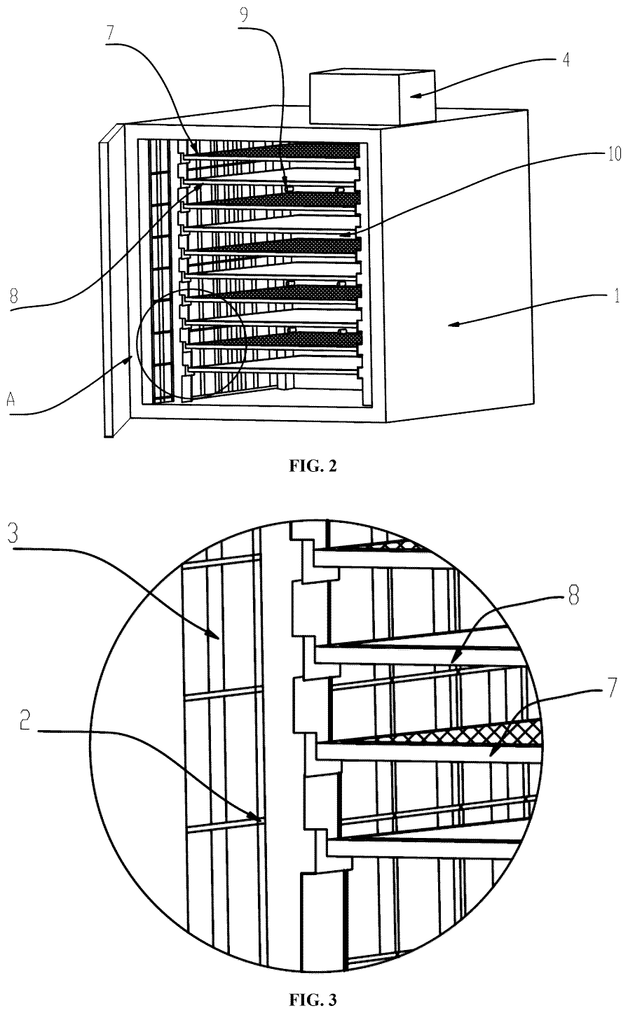

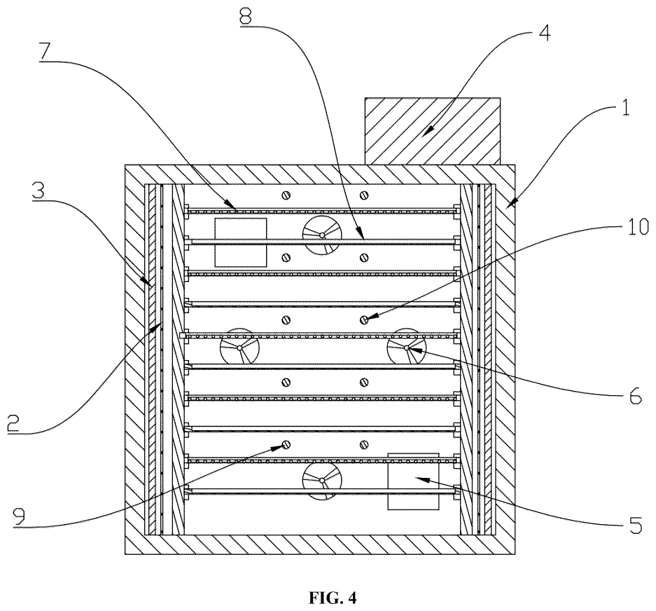

The technical solutions of the examples of the present disclosure are clearly and completely described below with reference to the drawings FIG. 1 to FIG. 4 in the examples of the present disclosure. Apparently, the described examples are merely part rather than all of the examples of the present disclosure. All other examples obtained by those skilled in the art based on the examples of the present disclosure without creative efforts shall fall within the protection scope of the present disclosure.

It should be understood that in the description of the present disclosure, terms such as “first” and “second” are used merely for a descriptive purpose, and should not be construed as indicating or implying relative importance, or implicitly indicating a quantity of indicated technical features. Thus, features defined with “first” and “second” may explicitly or implicitly include one or more of the features.

Referring to FIG. 1 to FIG. 4, examples of the present disclosure are as follows:

### Example 1

As shown in FIG. 1 to FIG. 4:

A baking process of high-quality green tea for beverage included the following steps:

1) A tea baking device was provided, including:
1.1) a box 1, where an inner side wall of the box 1 was provided with a partitioning mesh plate 2, and a vertical tubular far-infrared component, a heating component, a humidification component, a detection component, and a screening component were arranged inside the box 1;
2.2) the vertical tubular far-infrared component included a far-infrared heating quartz tube 3, where the far-infrared heating quartz tube 3 was fixedly arranged between the inner side wall of the box 1 and the partitioning mesh plate 2;
a control box 1, where the control box 1 was arranged at a top of the box 1, and the control box 1 was electrically connected to the far-infrared heating quartz tube 3 to control a heating temperature of the far-infrared heating quartz tube 3;
2.3) the heating component included an electric heater 5, where the electric heater 5 was arranged on the rear side wall in the box 1, and the electric heater was electrically connected to the control box 1; specifically, the electric heater 5 in this example had a corresponding thermal energy effect;
an exhaust fan 6, where the exhaust fan 6 was arranged on the side of the electric heater, and the exhaust fan 6 was electrically connected to the control box 1; in this example, there were 4 exhaust fans in total, and the control box 1 determined ON/OFF and wind speed frequency of the exhaust fans 6;
2.4) the humidification component was arranged inside the box 1, and the humidification component was electrically connected to the control box 1 to adjust the relative humidity inside the box 1;
2.5) the screening component included a tray 7, where the tray 7 were distributed at intervals inside the box 1, the bottom of the tray 7 was arranged in a mesh shape, and the tray 7 was drawable out of the box 1; the tray 7 in this example was made of stainless steel;
a vibrator, where the vibrator was fixedly connected to the tray 7, the vibrator was arranged on two sides of the tray 7, and the vibrator was electrically connected to the control box 1; specifically, four supporting columns were arranged at the bottom of the box, and each supporting column was provided with a limiting member; the trays 7 and the recovery grooves 8 were spaced apart and distributed on the limiting member, and the vibrator was arranged on the limiting member for limiting the trays; the trays were loaded on the vibrator and then limited by the limiting member; when the vibrator was turned on by the control box, the vibrator made the trays vibrate under the limit of the limiting member to screen the tea leaves;
a recovery groove 8, where the recovery groove 8 was distributed at intervals inside the box 1, and the recovery groove 8 was correspondingly arranged below the tray 7;
2.6) the detection components included a temperature sensor 9, where the temperature sensor 9 had one end fixedly arranged on the inner side wall of the box 1 and the other end extending above the tray 7, and the temperature sensor 9 was electrically connected to the control box 1 to feed back the temperature inside the box 1; and
a humidity sensor 10, where the humidity sensor 10 had one end fixedly arranged on the inner side wall of the box 1 and the other end extending above the tray 7, and the humidity sensor 10 was electrically connected to the control box 1 to feed back the humidity inside the box 1.

It should be noted that each layer of the trays was equipped with a corresponding temperature sensor 9 and a humidity sensor 10, and the two components fed back signals to the control box; staff could remotely check the control box to view the values fed back by the two components; there were many ways to remotely view sensors, which were relatively mature technologies at present and then should not be further limited.

2) First moisture regaining was conducted: a frozen green tea sample to be baked was placed in the tea baking device provided in step 1) to allow the first moisture regaining; where in this example, the green tea sample was placed in the tray 7, the box door was closed, the heating component and the humidification component were running to provide an ambient temperature of 30° C. and a relative humidity of 85% inside, and then the green tea sample was treated for 5 h during which the green tea sample was turned over every 1 h to reach a moisture content of 12%.

The frozen green tea sample in this example was green tea granules obtained through the processes of withering, rolling, shaping, and drying; the humidification component was a relatively mature technology, generally including a humidification pipe, where one end was connected to a water pump, and the water pump was arranged in a water tank, and the other end was connected to an atomizer; the water pump was electrically connected to the control box, and the ambient humidity in the box 1 was controlled by controlling the water pump; which was applied to achieve the humidification effect.

3) Baking preparation was conducted:

3.1) The green tea sample obtained after the first moisture regaining treatment was placed in a cooling trough to allow a primary standing treatment; where in this example, the green tea sample obtained after the first moisture regaining treatment was spread in the cooling trough and allowed to stand for 1 h, with a spreading thickness of 10 cm.

3.2) The green tea sample obtained after primary standing treatment was placed into cloth bags to allow a secondary standing; where in this example, the green tea sample obtained after the primary standing treatment was placed into the cloth bags such that each of the cloth bags had to 3 kg of the green tea sample and the green tea sample was spread at a spreading thickness of 10 cm, and allowed to stand for 30 min; the secondary standing in this example could make the moisture distribution of the tea leaves uniform and increase the moisture content of the tea leaves to meet the requirements of this example for baking.

4) Segmented baking was conducted:

4.1) The first stage was conducted:

4.1.1) The bagged green tea sample obtained after secondary standing treatment was placed in the box 1, and the box door was kept slightly open.

4.1.2) The vertical tubular far-infrared component, the heating component, and the humidification component were running to allow the first heating of the green tea sample placed in the box 1 at relatively constant temperature and humidity; where in this example, the vertical tubular far-infrared component and the heating component were running to reach an ambient temperature of 110° C. inside the box 1, the humidification component was running to reach a relative humidity of 15% inside the box 1, and then the green tea sample was heated for 3 min. The far-infrared component transferred heat energy inward through far-infrared radiation, and the tea leaves were heated evenly, which was conducive to quickly removing the odor in the tea leaves and reducing the moisture content; the box door was not entirely closed to prevent water vapor from accumulating in the box 1 and reduce the generation of stuffy tea water smell. For the first stage, the vertical tubular far-infrared component, the heating component, and the humidification component were used simultaneously to create a heating environment in order to remove the odor in the tea leaves and reduce the moisture content by rapidly heating up, reshaping the green tea leaves with high moisture content in a high-temperature and high-humidity environment; this process could in turn promote the leaching and transformation of the substances contained in the tea leaves, such that the aroma substances in the tea leaves were volatilized at a higher temperature, and the aroma became high and rich. It should be emphasized that turning on the heating component meant turning on the electric heater 5 and the exhaust fan 6 at the same time, namely the heat of the electric heater 5 was evenly dispersed to the inside of the box 1 through the wind of the exhaust fan 6, so as to promote the circulation of hot air in the box 1 while preventing the far-infrared radiation heat energy from being excessively accumulated.

4.1.3) The first heating ended when the green tea sample had a moisture content of 8%.

4.2) The second stage was conducted:

4.2.1) The green tea sample obtained after the first stage treatment was taken out from the cloth bags and then placed in the cooling trough to allow the second moisture regaining; where in this example, the green tea sample obtained after the first stage treatment was spread at a spreading thickness of 15 cm in the cooling trough to allow the second moisture regaining for 0.5 h.

4.2.2) The green tea sample obtained after the second moisture regaining treatment was spread on the tray 7 at a spreading thickness of 3 cm so that the tray 7 had 1.5 kg of the green tea sample, and then the box door was closed.

4.2.3) Only the heating component and the humidification component were running to allow the second heating of the green tea sample; where in this example, the heating component was running to provide an ambient temperature of 80° C. inside the box 1, the humidification component was running to provide a relative humidity of 15% inside the box 1, and then the green tea sample was heated for 20 min to fully transform flavor substances of the tea and improve overall aroma and taste quality of the tea. In this example, the heating environment was created by only using the heating component and the humidification component, and was achieved by using a medium-high temperature short baking method to improve the quality and aroma of the tea, making the tea taste mellower. In the second stage, when the moisture content of tea leaves was low, short baking at medium to high temperature was conducted to improve the quality and aroma of the tea leaves.

4.2.4) The second heating ended when the green tea sample had a moisture content of 5%; where in this example, a segmented baking process was applied for tea leaves with different moisture contents, making the tea leaves have the characteristics of abundant fragrance and mellow taste.

In this embodiment, it should be noted that the application of the heating component was equivalent to hot air baking, and hot air convection was conducted by the exhaust fans 6; and the vertical tubular far-infrared component was used for far-infrared baking, that is, heating and temperature rise were achieved through thermal radiation, and air circulation helped to heat evenly, which had a gain effect. However, normal far-infrared baking did not have the application of air circulation, the first stage adopted both the heating component and the vertical tubular far-infrared component to create a heating environment.

4.3) The third stage was conducted: the green tea sample obtained after the second stage treatment was subjected to vibratory screening, and taken out from the tray after the vibratory screening was completed; where in this example, the vibrator was running to allow green tea dregs in the tray 7 to fall into the recovery groove 8, the vibratory screening ended after no more green tea dregs fell from the tray 7, and the tray 7 was taken out. The prepared green tea was further screened by the vibrator to remove the broken dregs, thereby obtaining relatively complete green tea granules, and further improving the processing quality of this example.

5) Preservation was conducted: the green tea sample obtained after the vibratory screening treatment was cooled at the room temperature and then put into an aluminum foil bag to prevent from light, and then the photophobic aluminum foil bag containing the green tea sample was subjected to low-temperature preservation at 4° C.

During the baking, the tea leaves were put into the box 1, and then the far-infrared component, heating component, and humidification component were turned on. The exhaust fans were turned on to accelerate the air circulation in the box 1, and the output between each group was adjusted according to the values fed back by the temperature sensor 9 and the humidity sensor 10, so as to achieve precise control of the baking environment in the box 1. It should be noted that the control standard of the ambient temperature and humidity in the box 1 was to make the environment in the box 1 more accurate and to reduce the impact of environmental factors on the device. When the device was initially used, it was necessary to first adjust the ambient temperature in the box 1 and then put the tea leaves. After mastering the device setting values and the numerical error achieved by the output to the environment in the box 1, the tea leaves were put in and then the device was turned on as described above. The reason was that the device had been adapted and adjusted. After putting the tea leaves into the box 1, the device setting values corresponding to the environmental data to be obtained were directly set under the condition of considering the influence of environmental factors. If there was a slight error, further precise adjustment could be made according to the temperature sensor 9 and the humidity sensor 10, such that the green tea sample could be refined and baked through the variable temperature segmented baking process. After the baking was completed, the green tea sample was automatically screened through a feeding system, and then packaged and stored after being slightly cooled. The above processes could be completed by remotely operating the control box 1 to control each component, which was easy to operate and efficient.

### Comparative Example 1

A green tea sample used in this comparative example was not subjected to any baking treatment.

### Comparative Example 2

The green tea used in this comparative example was processed by traditional baking.

It should be emphasized that the tea sample in Example 1, Comparative Example 1, and Comparative Example 2 was the same tea sample before being treated, so as to form a more accurate data comparison. The specific data are shown in Table 1:

TABLE 1
Sensory evaluation results of green teas for beverage

| | Liquor color (20%) | | Aroma (40%) | | Taste (40%) | | Total |
|---|---|---|---|---|---|---|---|
| Sample | Evaluations | Score | Evaluations | Score | Evaluations | Score | score |
| Comparative | Yellow, | 87 | Strong brisk, | 90 | Slightly | 86.5 | 88.0 |
| Example 1 | bright | | slightly chestnut | | mellow, | | |
| Unbaked | | | aroma, slightly | | slightly | | |
| sample | | | green | | astringent | | |
| Comparative | Yellow, | 88 | Strong brisk, | 90 | Slightly | 87 | 88.8 |
| Example 2 | bright | | slightly chestnut | | mellow, | | |
| Traditional | | | aroma, tinily | | slightly | | |
| baking | | | fired aroma, | | astringent | | |
| | | | slightly green | | | | |
| Example 1 | Yellow, | 87.5 | Strong brisk, | 92 | Slightly | 88 | 89.5 |
| | bright | | slightly chestnut | | mellow, | | |
| | | | aroma, slightly | | slightly | | |
| | | | fired aroma | | sweet | | |

The specific components of different green tea samples obtained in the Example 1 and comparative examples were compared in detail and shown in Table 2:

TABLE 2
Quality components of green tea for beverage

| Quality | Comparative | Comparative | |
|---|---|---|---|
| component | Example 1 | Example 2 | Example 1 |
| Free amino | 2.688 ± 0.005 | 2.880 ± 0.021 | 2.962 ± 0.040 |
| acids (%) | | | |
| Polyphenols | 6.126 ± 0.004 | 5.702 ± 0.020 | 6.454 ± 0.023 |
| (%) | | | |
| Soluble solids | 0.459 ± 0.001 | 0.468 ± 0.001 | 0.530 ± 0.002 |
| (%) | | | |
| Caffeine | 115.57 ± 0.06 | 102.05 ± 0.19 | 104.58 ± 0.06 |
| (mg/g) | | | |

The contents of catechins in different green tea samples obtained in the Example 1 and comparative examples were compared in detail and shown in Table 3:

TABLE 3
The contents of catechins (mg/g)

| | Comparative | Comparative | |
|---|---|---|---|
| Component | Example 1 | Example 2 | Example 1 |
| GC | 21.62 ± 0.4 | 25.21 ± 0.37 | 28.625 ± 0.565 |
| EGC | 18.61 ± 0.05 | 21.96 ± 0.03 | 10.43 ± 0.24 |
| C | 4.99 ± 0.04 | 5.24 ± 0.03 | 5.56 ± 0.01 |
| EGCG | 170.91 ± 0.16 | 156.03 ± 0.225 | 192.88 ± 1.62 |
| EC | 88.05 ± 0.06 | 78.38 ± 0.38 | 96.79 ± 1.09 |
| GCG | 0.985 ± 0.005 | 1.52 ± 0.02 | 1.13 ± 0.02 |
| ECG | 33.53 ± 0.08 | 32.00 ± 0.02 | 39.56 ± 0.34 |
| CG | 6.88 ± 0.03 | 7.01 ± 0.02 | 7.53 ± 0.06 |
| Total | 316.09 ± 0.39 | 293.61 ± 0.685 | 345.22 ± 3.30 |

The contents of characteristic aroma component in different green teas obtained in the Example 1 and comparative examples were compared in detail and shown in Table 4:

TABLE 4
The contents of characteristic aroma components (μg/mL)

| | Comparative | Comparative | |
|---|---|---|---|
| Aroma component | Example 1 | Example 2 | Example 1 |
| 1-Octene-3-ol | 6.26 ± 0.00 | 9.98 ± 0.65 | 11.42 ± 1.81 |
| β-Cyclocitral | 64.11 ± 1.88 | 55.49 ± 0.97 | 75.12 ± 2.56 |
| α-Ionone | 12.20 ± 1.54 | 13.21 ± 0.01 | 23.39 ± 4.13 |
| β-Ionone | 103.05 ± 0.84 | 85.27 ± 0.06 | 140.21 ± 4.65 |
| Linalool | 107.70 ± 1.23 | 118.25 ± 1.29 | 141.85 ± 5.52 |
| Methyl salicylate | 14.36 ± 3.78 | 13.81 ± 3.54 | 17.82 ± 2.30 |
| 2,6-Diethylpyrazine | Not detected | 9.39 ± 0.39 | 10.44 ± 0.90 |
| 3.5-Diethyl-2- | Not detected | 2.29 ± 0.19 | 5.60 ± 0.86 |
| methylpyrazine | | | |

According to the comparison of Tables 1 to 4, it was seen that the raw material green tea for beverage prepared in the present disclosure had a rich taste and aroma, and could promote the dissolution of tea leaves' components in a short brewing time. The contents of free amino acids, polyphenols, and soluble solids in Example 1 were increased, the caffeine content was reduced, leading to the fact that the green tea taste was stronger and the bitterness was reduced. The contents of volatile components, including 1-octene-3-ol, β-cyclocitral, α-ionone, β-ionone, linalool, and methyl salicylate in Example 1 were relatively high, making the tea display heavy flower aroma. In addition, baking aroma substances, such as 2,6-diethylpyrazine and 3,5-diethyl-2-methylpyrazine, were also produced, changing the aroma of green tea from fresh to chestnut-like and roast.

The basic principles and main features of the present disclosure and the advantages of the present disclosure are illustrated and described above. For those skilled in the art, it is obvious that the present disclosure is not limited to the details of the above exemplary examples, and the present disclosure can be implemented in other specific forms without departing from the spirit or basic features of the present disclosure. Accordingly, the examples should be regarded in all points of view as exemplary and not restrictive, the scope of the present disclosure being defined by the appended claims rather than the foregoing description, and it is therefore intended that all changes falling within the meaning and scope of equivalent elements of the claims should be included in the present disclosure. Any reference numeral in the claims should not be considered as limiting the involved claims.

In addition, it should be understood that although this specification is described in accordance with the implementations, not each implementation only contains an independent technical solution, and this description in the specification is only for clarity. Those skilled in the art should take the specification as a whole. The technical solutions in the examples can also be properly combined to form other implementations that can be understood by those skilled in the art.

What is claimed is:

1. A tea baking device, comprising:
1.1) a box (1), wherein an inner side wall of the box (1) is provided with a partitioning mesh plate (2), and a vertical tubular far-infrared component, a heating component, a humidification component, a detection component, and a screening component are arranged inside the box (1);
2.2) the vertical tubular far-infrared component comprises a far-infrared heating quartz tube (3), wherein the far-infrared heating quartz tube (3) is fixedly arranged between the inner side wall of the box (1) and the partitioning mesh plate (2);
a control box (4), wherein the control box (4) is arranged at a top of the box (1), and the control box (4) is electrically connected to the far-infrared heating quartz tube (3) to control a heating temperature of the far-infrared heating quartz tube (3);
2.3) the heating component comprises an electric heater (5), wherein the electric heater (5) is arranged on a rear side wall in the box (1), and the electric heater is electrically connected to the control box (4);
an exhaust fan (6), wherein the exhaust fan (6) is arranged on one side of the electric heater, and the exhaust fan (6) is electrically connected to the control box (4);
2.4) the humidification component is arranged inside the box (1), and the humidification component is electrically connected to the control box (4) to adjust a relative humidity inside the box (1);
2.5) the screening component comprises a tray (7), wherein the tray (7) is distributed at intervals inside the box (1), a bottom of the tray (7) is arranged in a mesh shape, and the tray (7) is drawable out of the box (1);
a vibrator, wherein the vibrator is fixedly connected to the tray (7), the vibrator is arranged on two sides of the tray (7), and the vibrator is electrically connected to the control box (4);
a recovery groove (8), wherein the recovery groove (8) is distributed at intervals inside the box (1), and the recovery groove (8) is correspondingly arranged below the tray (7);
2.6) the detection components comprise a temperature sensor (9), wherein the temperature sensor (9) has one end fixedly arranged on the inner side wall of the box (1) and the other end extending above the tray (7), and the temperature sensor (9) is electrically connected to the control box (4) to provide feedback on a temperature inside the box (1); and
a humidity sensor (10), wherein the humidity sensor (10) has one end fixedly arranged on the inner side wall of the box (1) and the other end extending above the tray (7), and the humidity sensor (10) is electrically connected to the control box (4) to provide feedback on a humidity inside the box (1).

2. A baking process of high-quality green tea for a beverage using the tea baking device according to claim 1, comprising the following steps:
conducting a first moisture regaining treatment: placing a frozen green tea sample to be baked in the tea baking device provided in step 1) to allow the first moisture regaining treatment, such that the frozen green tea sample to be baked has a moisture content of 10% to 13%;
conducting baking preparation:
3.1) spreading a green tea sample obtained after the first moisture regaining treatment in a cooling trough to allow a primary standing treatment; and
3.2) placing a green tea sample obtained after the primary standing treatment into cloth bags to allow a secondary standing;
conducting segmented baking:
4.1) conducting a first stage treatment:
4.1.1) placing a bagged green tea sample obtained after the secondary standing treatment in the box (1), and keeping a box door slightly open;
4.1.2) turning on the vertical tubular far-infrared component, the heating component, and the humidification component to allow first heating of the green tea sample placed in the box (1) at relatively constant temperature and humidity; and
4.1.3) stopping the first heating when the green tea sample has a moisture content of 6% to 8%;
4.2) conducting a second stage treatment:
4.2.1) taking out a green tea sample obtained after the first stage treatment from the cloth bags and then placing in the cooling trough to allow a second moisture regaining treatment;
4.2.2) spreading a green tea sample obtained after the second moisture regaining treatment on the tray (7), and then closing the box door;
4.2.3) turning on only the heating component and the humidification component to allow second heating of the green tea sample; and
4.2.4) stopping the second heating when the green tea sample has a moisture content of 3% to 5%; and
4.3) conducting a third stage treatment: subjecting a green tea sample obtained after the second stage treatment to vibratory screening, and taking out from the tray (7) after the vibratory screening is completed; and
conducting preservation: cooling a green tea sample obtained after the vibratory screening treatment and then putting into an aluminum foil bag, and then subjecting the aluminum foil bag containing the green tea sample to low-temperature preservation.

3. The baking process according to claim 2, wherein the first moisture regaining in step 2) specifically comprises: placing the green tea sample in the tray (7), closing the box door, turning on the heating component and the humidification component such that the box (1) has an ambient temperature of 25° C. to 30° C. and a relative humidity of 80% to 85% inside, and then treating the green tea sample for 4 h to 6 h while turning over the green tea sample every 1 h.

4. The baking process according to claim 3, wherein the primary standing in step 3.1 specifically comprises: spreading the green tea sample obtained after the first moisture regaining treatment at a spreading thickness of 10 cm to 15 cm in the cooling trough to allow standing for 0.5 h to 1 h.

5. The baking process according to claim 4, wherein the secondary standing in step 3.2 specifically comprises: placing the green tea sample obtained after the primary standing treatment into the cloth bags such that each of the cloth bags has 3 kg to 5 kg of the green tea sample and the green tea sample is spread at a spreading thickness of 5 cm to 10 cm, and allowing to stand for 15 min to 30 min.

6. The baking process according to claim 5, wherein the first heating in step 4.1.2) specifically comprises: turning on the vertical tubular far-infrared component and the heating component such that the box (1) has an ambient temperature of 100° C. to 110° C. inside, turning on the humidification component such that the box (1) has a relative humidity of 15% to 20% inside, and then heating the green tea sample for 3 min to 5 min.

7. The baking process according to claim 2, wherein the second moisture regaining in step 4.2.1) specifically comprises: spreading the green tea sample obtained after the first stage treatment at a spreading thickness of 15 cm to 20 cm in the cooling trough to allow the second moisture regaining for 0.5 h to 1 h.

8. The baking process according to 7, wherein step 4.2.2) specifically comprises: spreading the green tea sample obtained after the second moisture regaining treatment on the tray (7) at a spreading thickness of 3 cm to 5 cm such that the tray (7) has 1.5 kg to 3 kg of the green tea sample, and then closing the box door.

9. The baking process according to claim 8, wherein the second heating in step 4.2.3) specifically comprises: turning on the heating component such that the box (1) has an ambient temperature of 80° C. to 90° C. inside, turning on the humidification component such that the box (1) has a relative humidity of 15% to 20% inside, and then heating the green tea sample for 10 min to 20 min.

10. The baking process according to claim 9, wherein the vibratory screening in step 4.3) specifically comprises: turning on the vibrator to allow green tea dregs in the tray (7) to fall into the recovery groove (8), and then stopping the vibratory screening after no more green tea dregs fall from the tray (7).

11. The baking process according to claim 10, wherein the green tea sample obtained after the vibratory screening treatment is cooled at a room temperature, and the low-temperature preservation is conducted at 4° C. to 8° C. in step 5).

12. The baking process according to claim 3, wherein the second moisture regaining in step 4.2.1) specifically comprises: spreading the green tea sample obtained after the first stage treatment at a spreading thickness of 15 cm to 20 cm in the cooling trough to allow the second moisture regaining for 0.5 h to 1 h.

13. The baking process according to claim 4, wherein the second moisture regaining in step 4.2.1) specifically comprises: spreading the green tea sample obtained after the first stage treatment at a spreading thickness of 15 cm to 20 cm in the cooling trough to allow the second moisture regaining for 0.5 h to 1 h.

14. The baking process according to claim 5, wherein the second moisture regaining in step 4.2.1) specifically comprises: spreading the green tea sample obtained after the first stage treatment at a spreading thickness of 15 cm to 20 cm in the cooling trough to allow the second moisture regaining for 0.5 h to 1 h.

15. The baking process according to claim 6, wherein the second moisture regaining in step 4.2.1) specifically comprises: spreading the green tea sample obtained after the first stage treatment at a spreading thickness of 15 cm to 20 cm in the cooling trough to allow the second moisture regaining for 0.5 h to 1 h.
